(19) United States
(12) Patent Application Publication
(10) Pub. No.: US 2025/0011134 A1
(43) Pub. Date: Jan. 9, 2025

(54) METHOD FOR INSTALLATION OF ROPING OF AN ELEVATOR AND ELEVATOR ARRANGEMENTS

(71) Applicant: Kone Corporation, Helsinki (FI)

(72) Inventors: Mikko KUKKOLA, Helsinki (FI); Mika IJÄS, Helsinki (FI); Anssi VENHO, Helsinki (FI); Matti RÄSÄNEN, Helsinki (FI); Markku HAAPANIEMI, Helsinki (FI)

(73) Assignee: Kone Corporation, Helsinki (FI)

(21) Appl. No.: 18/891,147

(22) Filed: Sep. 20, 2024

Related U.S. Application Data
(63) Continuation of application No. PCT/FI2022/050281, filed on Apr. 29, 2022.

(51) Int. Cl. B66B 19/02

(52) U.S. Cl. CPC B66B 19/02

(57) ABSTRACT

A method and arrangement for installation of roping of an elevator. The method comprises providing at least one rope, providing an elevator car comprising first and second rope clamps, routing the at least one rope to the elevator car and attaching to the first rope clamp(s), so that there is an extra length of the at least one rope extending past the first rope clamp(s), driving the elevator car to proximity of a motor pulley and installing the extra length on the motor pulley, attaching the extra length to the second rope clamp(s), releasing the at least one rope from the first rope clamp(s), driving the elevator car to a lower part of the elevator shaft, the ropes being attached to the second rope clamp(s), installing a length of the ropes including the extra length on a counterweight pulley, attaching extra length back to the elevator car, installing second end sections of the at least one rope to car pulleys arranged in the elevator car, attaching the second end sections to the elevator car, driving the elevator car to the upper part of the elevator shaft, and fixing the first rope ends and second rope ends to rope fixing(s) arranged in the upper part of the elevator shaft.

### CROSS-REFERENCE TO RELATED APPLICATION

This application is a continuation of PCT International Application No. PCT/FI2022/050281 which has an International filing date of Apr. 29, 2022, the entire contents of which are incorporated herein by reference.

### BACKGROUND

The invention relates to a method for installation of roping of an elevator.

The invention further relates to an elevator arrangement comprising an elevator car.

The invention still further relates to an elevator arrangement for executing the method.

A problem with known methods and arrangements for installation of roping of an elevator is that many methods and arrangements need to be used depending on e.g. the height of the elevator. Because of that, installation personnel needs to learn or memorize a large number of installation instructions. This may cause risks in installation work.

### BRIEF DESCRIPTION

Viewed from a first aspect, there can be provided a method for installation of roping of an elevator, comprising
providing at least one rope,
providing an elevator car comprising first and second rope clamps arranged therein,
routing the at least one rope to the elevator car and attaching the at least one rope to the first rope clamp(s), so that there is an extra length of the at least one rope extending past the first rope clamp(s), said extra length including first end(s) of the at least one rope,
driving the elevator car to an upper part of the elevator shaft in proximity of a motor pulley,
installing the extra length of the at least one rope on the motor pulley,
attaching the extra length of the at least one rope to the second rope clamp(s),
releasing the at least one rope from the first rope clamp(s),
driving the elevator car to a lower part of the elevator shaft, the ropes being attached to the second rope clamp(s),
providing a counterweight in the lower part of the elevator shaft,
installing a length of the ropes including the extra length on a counterweight pulley,
attaching the length of the at least one rope including the extra length of the at least one rope back to the elevator car,
installing second end sections of the at least one rope to car pulleys arranged in the elevator car,
attaching the second end sections of the at least one rope to the elevator car,
driving the elevator car to the upper part of the elevator shaft, and
fixing the first rope ends and second rope ends at the second end sections of the at least one rope to rope fixing(s) arranged in the upper part of the elevator shaft.

Thereby a method for installation of roping of an elevator that can be used regardless of the height of the elevator may be achieved.

Viewed from a further aspect, there can be provided an elevator arrangement comprising an elevator car, the elevator car comprising at least one first rope clamp and at least one second rope clamp, said rope clamps being arranged for receiving and detachably attaching at least one rope of an elevator roping.

Thereby an elevator arrangement enabling the method disclosed above may be achieved.

Viewed from a still further aspect, there can be provided an elevator arrangement for executing the method described in this description.

Thereby an elevator arrangement enabling the method disclosed above may be achieved.

The arrangement and the methods are characterised by what is stated in the independent claims. Some other embodiments are characterised by what is stated in the other claims. Inventive embodiments are also disclosed in the specification and drawings of this patent application. The inventive content of the patent application may also be defined in other ways than defined in the following claims. The inventive content may also be formed of several separate inventions, especially if the invention is examined in the light of expressed or implicit sub-tasks or in view of obtained benefits or benefit groups. Some of the definitions contained in the following claims may then be unnecessary in view of the separate inventive ideas. Features of the different embodiments of the invention may, within the scope of the basic inventive idea, be applied to other embodiments.

In one embodiment, it is provided the at least one rope on the lowest floor of the elevator shaft or in a pit of the elevator shaft.

An advantage is that typically the lowest floor or the pit is easy and simple to reach by personnel taking care of the rope(s).

In one embodiment, the at least one rope is provided on reel(s).

An advantage is that handling of the rope(s) is easy.

In one embodiment, the elevator car is arranged to the lowest floor of the elevator shaft, and then the at least one rope is routed to the elevator car and attaching the at least one rope to the first rope clamp(s), so that there is the extra length of the at least one rope.

An advantage is that the elevator car is easy to reach and the height where the rope(s) need(s) to be lift can be minimized.

In one embodiment, the first and second rope clamps are arranged to a car frame of the elevator car.

An advantage is that the car frame is dimensioned for carrying high loads and therefore it may serve as a robust platform for the rope clamps.

In one embodiment, the first and second rope clamps are arranged on a roof of the elevator car.

An advantage is that personnel taking care of the rope clamps may easily and safely reach the clamps through or on the roof.

In one embodiment of the method, the counterweight is first arranged on a buffer or on an installation clamp.

An advantage is that a simple way to support the counterweight while carrying out the method may be achieved.

In one embodiment, following the installing the at least one rope on the counterweight pulley, the extra length of the at least one rope, including first end(s) of the at least one rope, is attached back to the second rope clamp(s).

An advantage is that the second rope clamp(s) can be utilized before and also after the installing the rope(s) on the counterweight pulley, and thus there is no need for extra or third clamp(s).

In one embodiment, the motor pulley lies in the elevator shaft.

An advantage is that the motor pulley can be easily reached by personnel working from/on the elevator car.

In one embodiment, the method is realized in a construction time use (CTU) elevator shaft.

An advantage is that also the roping of the CTU may be simplified.

In one embodiment, the CTU is provided with a removable protection deck, the protection deck dividing the elevator shaft in a lower and an upper section, and the roping is installed in said lower section only.

An advantage is that building the elevator can be carried out in the upper section, while the lower section can be used for transportation tasks.

In one embodiment of the method, filling of the counterweight with filler weights is completed just prior to fixing the first and the second rope ends to rope the fixings.

An advantage is that movements of a lighter counterweight may lower energy consumption of the method.

In one embodiment, the elevator car is driven in the elevator shaft by a hoist removable from the elevator shaft, such as a man riding hoist.

An advantage is that movements of the elevator car can be realized easily and safely.

### BRIEF DESCRIPTION OF FIGURES

Some embodiments illustrating the present disclosure are described in more detail in the attached drawings, in which

FIG. 1 is a schematic view of a method and arrangement in partial cross-section,

FIG. 2 is another schematic view of the method and arrangement shown in FIG. 1 in partial cross-section,

FIG. 3 is third schematic view of the method and arrangement shown in FIG. 1 in partial cross-section,

FIG. 4 is fourth schematic view of the method and arrangement shown in FIG. 1 in partial cross-section,

FIG. 5 is a schematic view of another method and arrangement in partial cross-section, and

FIG. 6 illustrates a method for installation of roping of an elevator.

In the figures, some embodiments are shown simplified for the sake of clarity. Similar parts are marked with the same reference numbers in the figures.

### DETAILED DESCRIPTION

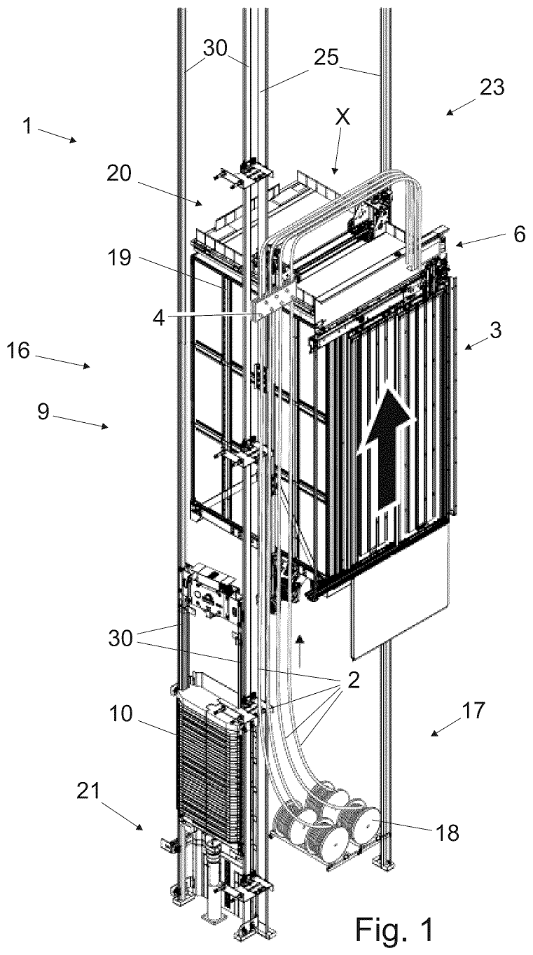

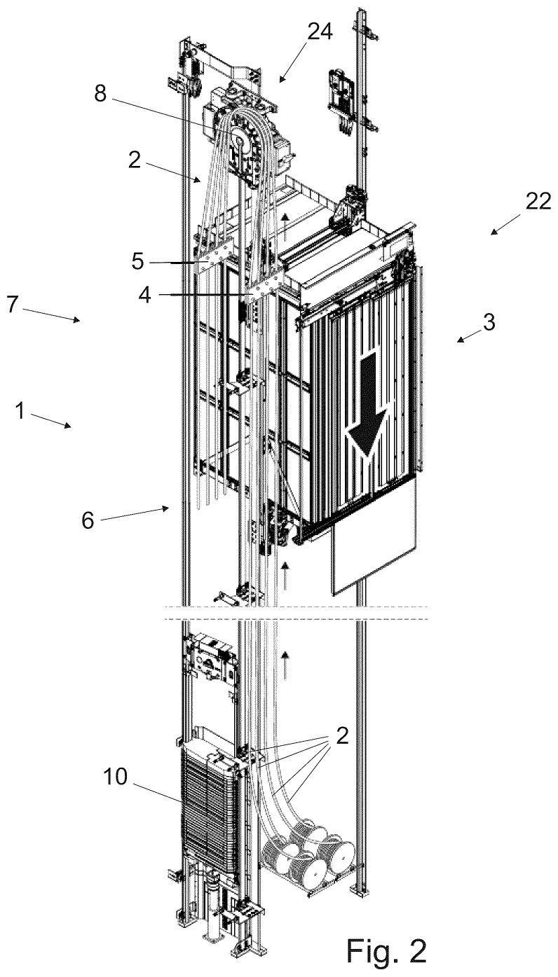

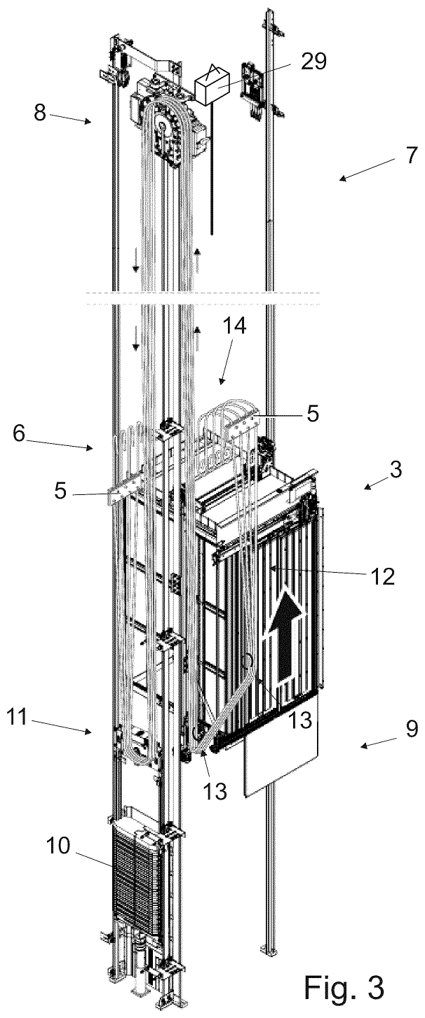

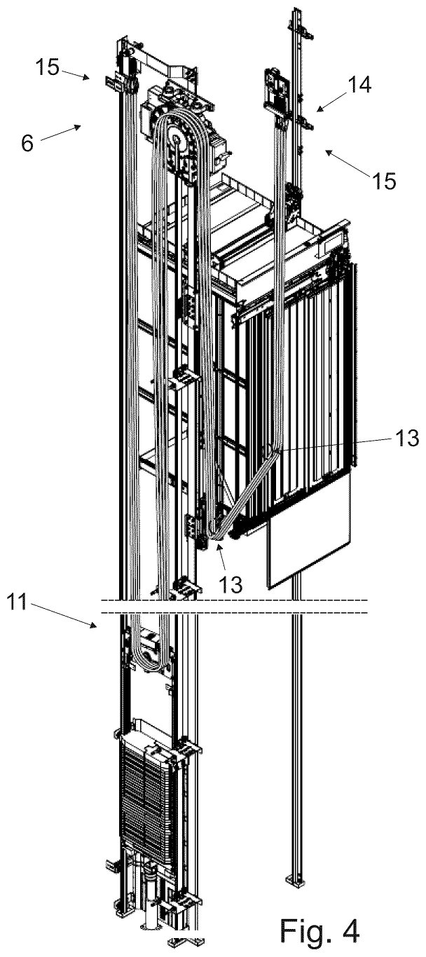

FIG. 1 is a schematic view of a method and arrangement in partial cross-section, FIG. 2 is another schematic view of the method and arrangement shown in FIG. 1 in partial cross-section, FIG. 3 is third schematic view of the method and arrangement shown in FIG. 1 in partial cross-section, and FIG. 4 is fourth schematic view of the method and arrangement shown in FIG. 1 in partial cross-section.

The figures are showing the method and the arrangement in an elevator having a roping ratio of 2:1. However, it is clear that the method and the arrangement described and illustrated in this disclosure are also suitable for elevators having another roping ratios, such as 4:1 or 6:1, by e.g. arranging further pulley(s) to the roping.

In the method, it is provided at least one rope 2 from which the roping will be constructed. Typically, there are more than one rope 2 that are arranged and running side by side in the roping. In the embodiment shown in FIG. 1, there are four ropes side by side. The rope 2 may be manufactured, for instance, from plurality of strands made of steel or polymeric materials or combinations thereof.

In one embodiment, the ropes 2 are provided on reels 18.

In one embodiment, the ropes 2 are provided on the lowest floor 16 of the elevator shaft. In another embodiment, the ropes 2 are provided in a pit 17 of the elevator shaft.

In the method, it is provided an elevator car 3. In one embodiment, the elevator car 3 is primarily meant for transporting passengers. In one embodiment, the elevator car 3 is primarily meant for transporting goods and materials.

The elevator car 3 comprises first and second rope clamps 4, 5. The rope clamp 4, 5 has a structure that is able to receive and detachably attach at least one of the rope(s) 2.

In one embodiment, there just one first clamp 4 in the elevator car, the clamp having capacity to receive and detachably attach all the ropes 2 from which the roping will be constructed. In another embodiment, there are plurality of first clamps 4.

In one embodiment, there just one second clamp 5 in the elevator car having capacity to receive and detachably attach all the ropes 2 from which the roping will be constructed. In another embodiment, there are plurality of second clamps 5.

In one embodiment, at least one of the rope clamps 4, 5 is arranged on the roof 20 of the elevator car. In one embodiment, all the rope clamps are arranged on the roof of the elevator car.

In one embodiment, at least one of the rope clamps 4, 5 is arranged to a frame 19 of the elevator car. In one embodiment, all the rope clamps are arranged to said frame 19.

The structure of the first and second clamps 4, 5 may vary. In one embodiment, such as shown in the Figures, the clamp comprises two parallelly arranged plates. Plate surfaces facing each other may have groove(s) for receiving the rope(s) between the plates. The plates are pressed against the rope(s) therebetween by tightening bolts or like means to the extent that the rope(s) is/are firmly held in the clamp.

In the method, the rope(s) 2 is/are routed to the elevator car 3 and the attached to the first rope clamp(s) 4. This step is made so that an extra length X of the rope(s) is provided in the rope(s) extending past the first rope clamp(s) 4. The extra length X includes first end(s) 6 of the rope(s). The length of the extra length X is selected according to dimensions and properties of the elevator. In one embodiment, the extra length X is about 5 meters.

In one embodiment, prior to the above-mentioned step where the rope(s) 2 is/are routed to the elevator car 3 and the attached to the first rope clamp(s) 4, the elevator car 3 is arranged to the lowest floor 16 of the elevator shaft 23.

Following attaching the rope(s) 2 to the first rope clamp(s) 4, the elevator car 3 is driven to an upper part of the elevator shaft 7 in proximity of a motor pulley 8. In one embodiment, the elevator car 3 is driven to an uppermost floor 22 of the elevator shaft, and then the extra length X of the rope(s) is/are installed on the motor pulley 8. It is to be noted here that the term “motor pulley” covers not only motor pulleys but also motor sheaves and drive sheaves. In other words, the motor pulley may also be an element that is called as a motor sheave or a drive sheave.

In one embodiment, such as shown in FIG. 2, the motor pulley 8 lies inside the elevator shaft 23. In one embodiment where the motor pulley 8 lies inside the elevator shaft 23, the motor pulley 8 is run by a motor 24 that is attached to an elevator car guide 25.

The elevator car 3 can be driven up and down in the elevator shaft 23 by e.g. a hoist 29. In one embodiment, the hoist is a man riding hoist. The hoist is preferably arranged so that it can be removed from the elevator shaft when it is not needed anymore.

As the elevator car 3 is driven in proximity of the motor pulley 8, the extra length X of the rope(s) is/are installed on the motor pulley 8, and following this, the extra length X of the rope(s) is/are attached to the second rope clamp(s) 5.

As the rope(s) has/have been attached to the second rope clamp(s) 5, the rope(s) is/are released from the first rope clamp(s) 4. In one embodiment, the “releasing” means that the rope is still in the clamp, but it can slide through said clamp.

In the method, it is provided a counterweight 10 in the lower 9 part of the elevator shaft. In one embodiment, the counterweight 10 is arranged on a counterweight buffer 21 or on an installation clamp (not shown). The counterweight 10 is fitted to one or more counterweight guide(s) 30 arranged for guiding the movements of the counterweight in the elevator shaft.

In one embodiment, the counterweight 10 comprises plurality of filler weights that can be added to the counterweight one by one. In one embodiment, the counterweight 10 provided to and used in the method is filled with the filler weights so that the counterweight weights only part of the weight needed when the elevator is in use. In one embodiment, the counterweight 10 weights only about 40% of the weight of a completed elevator. The missing weight, i.e. about 60%, is added at later stage of the method.

The elevator car 3 is driven to a lower 9 part of the elevator shaft, the ropes being attached to the second rope clamp(s) 5. In one embodiment, the elevator car 3 is driven to the lowest floor 16. As the rope(s) is/are attached to the second rope clamp(s) 5, the movement of the elevator car draws the rope(s) and causes it/them to uncoil from the reel(s) 18.

Then a length of the rope(s) 2 including the extra length X is/are installed on a counterweight pulley 11 of the counterweight, and then attached to the elevator car 3.

In one embodiment, the rope(s) 2 is/are released from the second rope clamp(s) 5 prior to installing the rope(s) 2 on the counterweight pulley 11 and attached back to the second rope clamp(s) 5 after installing the rope(s) on the counterweight pulley.

Then in the method, the second end sections 12 of the rope(s) is/are installed to car pulleys 13 arranged in the elevator car. Said second end section 12 is at the end of the rope that is opposite to the first end of said rope. If the rope 2 is provided on the reel 18, said second end section is typically the last section uncoiled from the reel.

The car pulley 13 is typically arranged on a bottom-side of the elevator car.

Following installation of the rope(s) on the car pulleys 13, the second end section(s) 12 of the rope(s) is/are attached to the elevator car 3. Then, the elevator car 3 is driven to the upper part 7 of the elevator shaft, such as to the uppermost floor 22, the second end section(s) 12 of the rope(s) as well as the first rope end(s) 6 following the elevator car. In the upper part 7 of the elevator shaft there are arranged rope fixings 15. The first rope end(s) 6 and second rope ends 14 at the second end sections 12 of the ropes are fixed to the rope fixings 15, for instance as shown in FIG. 4.

In one embodiment, filling the counterweight 10 with filler weights is completed just prior to fixing the first and the second rope ends 6, 14 to the fixings 15.

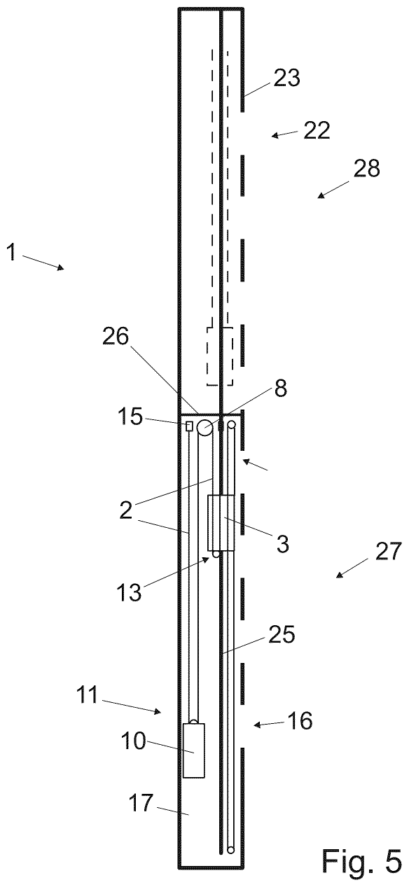

FIG. 5 is a schematic view of another method and arrangement in partial cross-section.

As described above and shown in the previous figures, some embodiments of the method and the arrangement may be adapted to elevators 1 the shaft of which is already finished. However, in some other embodiments, the method and the arrangement are adapted to construction time use (CTU) elevator shafts. Construction time use elevators are temporarily-installed elevators used for transporting passengers and materials vertically in and out of a building during its construction.

In one embodiment, the method is realized in and the arrangement adapted to an unfinished elevator shaft 23 of a building. In one embodiment, such as shown in FIG. 5, the method comprises arranging a removable protection deck 26 in the construction time use (CTU) elevator shaft. The protection deck 26 divides the elevator shaft 23 in a lower section 27 and an upper section 28. The lower section 27 is in such condition that an elevator car 3 can be arranged therein and thus the roping has been installed in said lower section only. As the construction of the elevator proceeds, the protection deck 26 can be detached from the elevator shaft and moved further upwards in another position in the The elevator car 3 is able to move for transporting passengers and/or materials in the lower section 27. Meanwhile in the upper section 28, the elevator shaft can be under construction. The protection deck 26 separating the lower and the upper sections may prevent any construction work taking place in the upper section 28 from hampering the transportation tasks of the elevator car in the lower section 27.

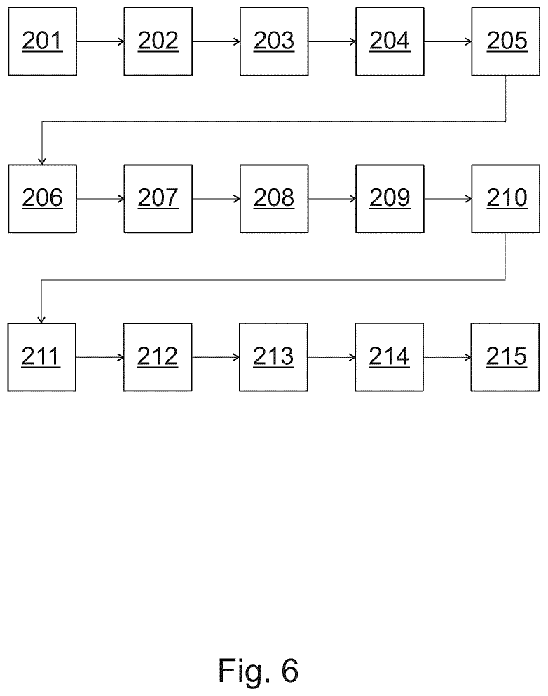

FIG. 6 illustrates a method for installation of roping of an elevator. The method comprises steps of
providing 201 at least one rope,
providing 202 an elevator car comprising first and second rope clamps arranged therein,
routing 203 the at least one rope to the elevator car and attaching the at least one rope to the first rope clamp(s), so that there is an extra length of the at least one rope extending past the first rope clamp(s), said extra length including first end(s) of the at least one rope,
driving 204 the elevator car to an upper part of the elevator shaft in proximity of a motor pulley,
installing 205 the extra length of the at least one rope on the motor pulley,
attaching 206 the extra length of the at least one rope to the second rope clamp(s),
releasing 207 the at least one rope from the first rope clamp(s),
driving 208 the elevator car to a lower part of the elevator shaft, the ropes being attached to the second rope clamp(s),
providing 209 a counterweight in the lower part of the elevator shaft,
installing 210 a length of the ropes including the extra length on a counterweight pulley,
attaching 211 the length of the at least one rope including the extra length of the at least one rope back to the elevator car,
installing 212 second end sections of the at least one rope to car pulleys arranged in the elevator car,
attaching 213 the second end sections of the at least one rope to the elevator car,
driving 214 the elevator car to the upper part of the elevator shaft, and
fixing 215 the first rope ends and second rope ends at the second end sections of the at least one rope to rope fixing(s) arranged in the upper part of the elevator shaft.

The invention is not limited solely to the embodiments described above, but instead many variations are possible within the scope of the inventive concept defined by the claims below. Within the scope of the inventive concept the attributes of different embodiments and applications can be used in conjunction with or replace the attributes of another embodiment or application.

The drawings and the related description are only intended to illustrate the idea of the invention. The invention may vary in detail within the scope of the inventive idea defined in the following claims.

### REFERENCE SYMBOLS

1 elevator
2 rope
3 elevator car
4 first rope clamp
5 second rope clamp
6 first rope end
7 upper part of the elevator shaft
8 motor pulley
9 lower part of the elevator shaft
10 counterweight
11 counterweight pulley
12 second end section of the rope
13 car pulley
14 second rope end
15 rope fixing
16 lowest floor
17 pit
18 reel
19 car frame
20 roof
21 buffer
22 uppermost floor
23 elevator shaft
24 motor
25 elevator car guide
26 protection deck
27 lower section
28 upper section
29 hoist
30 counterweight guide
200-215 method steps
X extra length

1. A method for installation of roping of an elevator, comprising
providing at least one rope,
providing an elevator car comprising first and second rope clamps arranged therein,
routing the at least one rope to the elevator car and attaching the at least one rope to the first rope clamp(s), so that there is an extra length of the at least one rope extending past the first rope clamp(s), said extra length including first end(s) of the at least one rope,
driving the elevator car to an upper part of the elevator shaft in proximity of a motor pulley,
installing the extra length of the at least one rope on the motor pulley,
attaching the extra length of the at least one rope to the second rope clamp(s),
releasing the at least one rope from the first rope clamp(s),
driving the elevator car to a lower part of the elevator shaft, the ropes being attached to the second rope clamp(s),
providing a counterweight in the lower part of the elevator shaft,
installing a length of the ropes including the extra length on a counterweight pulley,
attaching the length of the at least one rope including the extra length of the at least one rope back to the elevator car,
installing second end sections of the at least one rope to car pulleys arranged in the elevator car,
attaching the second end sections of the at least one rope to the elevator car,
driving the elevator car to the upper part of the elevator shaft, and
fixing the first rope ends and second rope ends at the second end sections of the at least one rope to rope fixing(s) arranged in the upper part of the elevator shaft.

2. The method as claimed in claim 1, comprising
providing the at least one rope on the lowest floor of the elevator shaft or in a pit of the elevator shaft, preferably
providing the at least one rope on reel(s).

3. The method as claimed in claim 1, comprising
arranging the elevator car to the lowest floor of the elevator shaft, and then
routing the at least one rope to the elevator car and attaching the at least one rope to the first rope clamp(s), so that there is the extra length of the at least one rope.

4. The method as claimed in claim 1, wherein
the first and second rope clamps are arranged to a car frame of the elevator car, and/or
the first and second rope clamps are arranged on a roof of the elevator car.

5. The method as claimed in claim 1, comprising
arranging the counterweight on a buffer or on an installation clamp.

6. The method as claimed in claim 1, comprising
driving the elevator car to an uppermost floor in proximity of a motor pulley, and then
installing the extra length of the at least one rope on the motor pulley.

7. The method as claimed in claim 1, comprising
following driving the elevator car to the lowest floor, the second end sections of the at least one rope are attached to the first rope clamp(s).

8. The method as claimed in claim 1, comprising
driving the elevator car to the uppermost floor and then
fixing the first rope ends and the second rope ends to the rope fixings.

9. The method as claimed in claim 1, comprising
following the installing the at least one rope on the counterweight pulley,
attaching the extra length of the at least one rope, including first ends of the at least one rope, back to the second rope clamp(s).

10. The method as claimed in claim 1, wherein
the motor pulley lies in the elevator shaft, and
the motor pulley is run by a motor attached to an elevator car guide.

11. The method as claimed in claim 1, wherein
the method is realized in a construction time use (CTU) elevator shaft, and the method comprises
arranging a removable protection deck in the construction time use (CTU) elevator shaft, the protection deck dividing the elevator shaft in a lower and an upper section, and
installing the roping in said lower section only.

12. The method as claimed in claim 1, comprising
completing filling the counterweight with filler weights just prior to fixing the first and the second rope ends to rope the fixings.

13. The method as claimed in claim 1, comprising
driving the elevator car in the elevator shaft by a hoist removable from the elevator shaft, such as a man riding hoist.

14. An elevator arrangement comprising an elevator car, the elevator car comprising
at least one first rope clamp and
at least one second rope clamp,
said rope clamps being arranged for receiving and detachably attaching at least one rope of an elevator roping, wherein
at least one of the rope clamps is arranged on the roof of the elevator car, preferably all the rope clamps are arranged on the roof of the elevator car and/or
at least one of the rope clamps is arranged to a frame of the elevator car, preferably all the rope clamps are arranged to the frame of the elevator car.

15. An elevator arrangement for executing the method as claimed in claim 1.
